(19) United States
(12) Patent Application Publication
(10) Pub. No.: US 2001/0019186 A1
(43) Pub. Date: Sep. 6, 2001

(54) Extrusion of parison for suction/blowing molding system

(75) Inventors: Heinz-Dieter Hilgers, Troisdorf (DE); Frank Schuller, Frechen (DE)

Correspondence Address: THE FIRM OF KARL F ROSS, 5676 RIVERDALE AVENUE, PO BOX 900, RIVERDALE (BRONX), NY, 10471-0900, US

(73) Assignee: FISCHER-W. MULLER BLASFORMTECHNIK GmbH

(21) Appl. No.: 09/790,120

(22) Filed: Feb. 21, 2001

(30) Foreign Application Priority Data
Feb. 21, 2000 (DE) 10007870.2

(51) Int. Cl. B29C 45/14; B29C 49/00

(52) U.S. Cl. 264/515; 425/532

(57) ABSTRACT

A molding system has an extruder for concentrically extruding an outer tubular strand having an inner diameter and an inner tubular strand having an outer diameter from respective annular nozzle openings defined between respective inner and outer nozzle walls. The outer strand at least is are of a resin that swells transversely as it issue from the respective nozzle opening. The nozzle walls are positioned such that the outer diameter of the inner strand is substantially smaller than the inner diameter of the outer strand and the inner strand is separated by a space from the outer strand as the strands issue from the respective nozzle openings. An outer wall of the inner strand engages an inner wall of the outer strand at a spacing from the nozzle openings after substantially all swelling of the strands has taken place. A closeable mold has a passage for drawing the strands through the passage by applying suction to a downstream end of the passage.

### FIELD OF THE INVENTION

The present invention relates to a suction/blowing molding system. More particularly this invention concerns the extrusion of the parison for such a system.

### BACKGROUND OF THE INVENTION

In a standard suction/blowing mold system for producing complex three-dimensional hollow articles, typically of plastic, a hollow parison or preform having a closed leading end is produced by an extruding apparatus. This leading end is engaged in an upper intake end of a die passage formed between two fitted-together female die halves and of somewhat greater cross-sectional size than the preform. Suction is applied to the opposite lower or output end of the die passage to draw the preform while it is still warm and soft down through the mold as it is either emitted by the extruding apparatus or advanced by a manipulator.

Once the preform is threaded completely through the mold cavity, its leading and trailing ends are pinched closed at the upper and lower passage ends. A needle is then inserted centrally into the preform and gas is blown into it to expand it to fill the mold cavity. Once the material of the preform has cured, the mold is opened and the finished workpiece is removed. It will have the exact shape of the mold passage with no flashing or sprues. In particular its inner surface will be perfectly smooth and without seams. Such a system, as described in “Technische Mitteilungen Krupp” (2/1998/ pages 49/50), is used, for instance, to make complexly shaped manifold or feed tubes for appliances.

U.S. Pat. No. 4,717,326 describes an extruder nozzle for producing a layered preform produced by a nozzle having a plurality of concentric annular nozzle openings from each of which is extruded a respective resin or a material serving to bond resin layers together. In this manner a workpiece can be produced having layers whose primary function is to give good structural strength to the workpiece and other layers forming barriers for substances such as solvents that might perfuse through the structural layers, for instance for use as a gas tank or fuel line.

The problem with these systems is that the tubular strands issuing from the various nozzle openings invariably swell somewhat once they escape the pressure of the extruder that is forcing them through the nozzle. Since these tubular strands also merge together just as they leave the nozzle, this means that the overall outside diameter of the resultant multilayer parison will increase and its inside diameter will decrease. In fact it is fairly common for the swelling effect to be sufficient to actually close the innermost tubular strand, producing a solid workpiece that cannot be used in the suction/blowing molding system.

This problem is even compounded when the strand is emitted such that different portions have different wall thicknesses, as is necessary to produce certain complexly shaped articles. In this situation the swelling effect where the wall thickness is at its greatest is exaggerated, leading to local occlusion of the multilayer tubular strand. Normally the inside diameter must not drop below about 10 mm as the pressurizing needle cannot otherwise be counted on to properly inflate the parison once in the mold. Attempts to pressurize the interior of the parison as it is being extruded are rarely successful in keeping the central passage through the strand open, especially n situations of varying wall thickness.

### OBJECTS OF THE INVENTION

It is therefore an object of the present invention to provide an improved suction/blowing molding system.

Another object is the provision of such an improved suction/blowing molding system which overcomes the above-given disadvantages, that is which allows multilayer workpieces even of varying wall thickness to be accurately extruded and shaped.

### SUMMARY OF THE INVENTION

A molding system has according to the invention an extruder for concentrically extruding an outer tubular strand having an inner diameter and an inner tubular strand having an outer diameter from respective annular nozzle openings defined between respective inner and outer nozzle walls. At least the outer strands is of a resin that swells transversely as it issues from the outer nozzle opening. The nozzle walls are positioned in accordance with the invention such that the outer diameter of the inner strand is substantially smaller than the inner diameter of the outer strand and the inner strand is separated by a space from the outer strand as the strands issue from the respective nozzle openings. An outer wall of the inner strand engages an inner wall of the outer strand at a spacing from the nozzle openings after substantially all swelling of the strands has taken place. A closeable mold has a passage for drawing the strands through the passage by applying suction to a downstream end of the passage.

Thus with this system it is possible to extrude an outer tubular strand of widely varying thickness without having to worry about occluding the inner strand. Only after the strands have been allowed to swell to their natural sizes are they joined together, so that even if an extra-thick region is formed in the outer strand, the inner strand will remain open. The need to make complexly shaped parts out of two pieces is eliminated; instead the more desirable blowing/molding method can be used.

### BRIEF DESCRIPTION OF THE DRAWING

The above and other objects, features, and advantages will become more readily apparent from the following description, reference being made to the accompanying drawing in which:

FIG. 1 is a largely schematic view illustrating a suction/blowing apparatus at the end of a molding cycle;

FIG. 2 is a section through a prior-art extrusion nozzle;

FIG. 3 is a section through an extrusion nozzle in accordance with the invention; and

FIG. 4 is a larger-scale view of a detail of FIG. 3.

### SPECIFIC DESCRIPTION

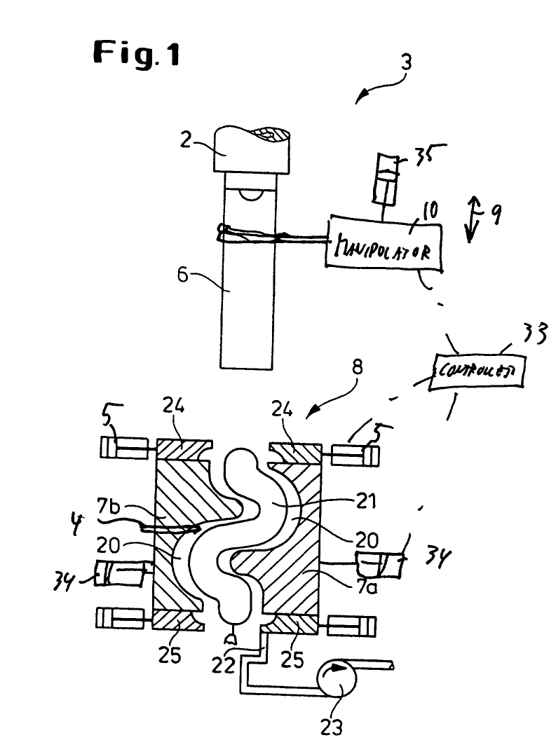

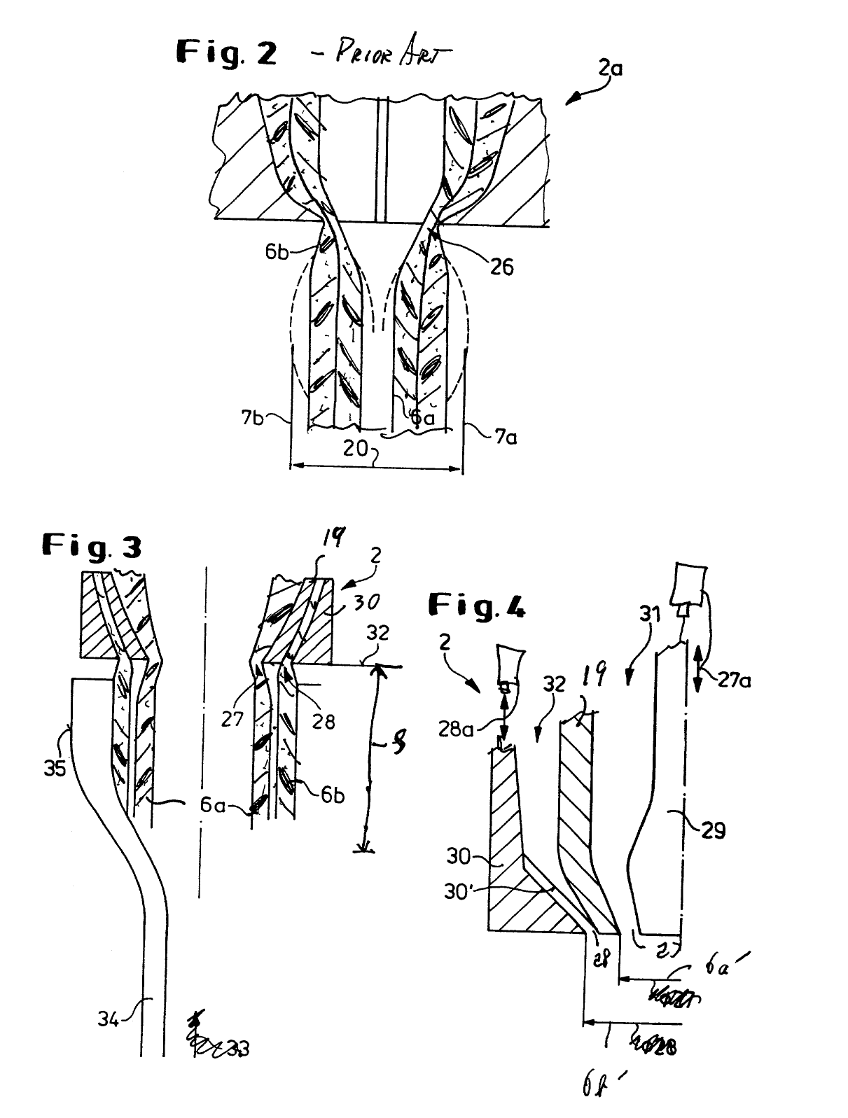

As seen in FIG. 1 a extruder system 3 has a head 2 that produces a preform 6 engaged by a handler or manipulator 10 movable by an actuator 35 in a direction 9 toward and away from a mold 8 having a pair of female mold halves 7a and 7b forming a nonstraight passage 20 having an upper intake end and a lower output end. At the start of a mold cycle the two mold halves 7a and 7b are closed together by hydraulic actuators 34 and suction is applied by a suction conduit 22 from a pump 23 to the bottom of the passage cavity 20 to suck the preform 6 down through it, as the preform 6 is being extruded from the nozzle 2 and/or advanced by the manipulator 10.

Once a leading end of the preform 6 is at a lower end of the cavity 20, upper and lower pinchers 24 and 25 are closed by respective actuators 5 and 6 to pinch off the trailing and leading ends of the preform 6. Then a needle 4 is poked into a central region of the preform 6 to inflate it to a finished workpiece 21 that is cured in the mold 8. Thereafter the mold 8 is opened, the pinchers 24 and 25 are released, and the finished workpiece 21 is removed from the open mold. A common computer-type controller 33 operates the actuators 5, 6 and 34 as well as the extruder system 3 and the actuator 35 of the manipulator 10.

In a standard prior-art system, inner and outer strands 6a and 6b are coextruded from a common opening 26 of a nozzle 2a. The two strands 6a and 6b join immediately as they issue from the opening 26 so that swelling as shown at the inner and outer dashed lines will on the one hand tend to close off the interior of the inner strand 6a and on the other hand increase the outside diameter of the outer strand 6b so that it cannot readily fit into the passage between the mold parts 7a and 7b. This is particularly the case when the outer strand 6b has been made extra thick for formation of a flange or the like.

According to the invention as shown in FIGS. 3 and 4 the tubular inner and outer strands 6a and 6b are produced from respective circular nozzle openings 27 and 28 defined between an outer wall 30, an inner wall 29, and an intermediate wall 19 and opening at a plane 32. The intermediate wall 19 is normally stationary and its inner and outer surfaces form with the outer and inner surfaces of the walls 29 and 30 a pair of passages 31 and 32 that open at the respective openings 27 and 28. Actuators 27a and 28a are connected to the inner wall 29 and outer wall 30 to axially move them and thereby vary the diameters 6a′ and 6b′ of the strands 6a and 6b that issue from the openings 27 and 28. The outer wall 39 can also be moved up as shown at 30′ to contact the intermediate wall 19 and completely close the opening 28 if the inner strand 6a needs no reinforcement in a certain region, A and can of course be dropped well down to provide an extra-thick layer of reinforcement.

The extruder nozzle according to the invention can correspond generally to that of German patent 1,039,224 based on a US patent application filed May 11, 1954 by Owens Illinois Glass Company. This prior-art nozzle is intended to produce a multilayer tube for a different purpose and in a different manner.

With this arrangement the reinforcing outer strand 6b only joins the inner strand 6a at a spacing S from the plane 32, after any transverse swelling of the strands 6a and 6b. The outside diameter 6a′ of the inner strand 6a is always smaller than the inside diameter 6b′ of the outer strand 6b so that the inner strand 6a will always remain open.

This makes it possible to produce a finished workpiece 34 that is generally quite thin but has thick parts 35 which are of large diameter and also considerable wall thickness.

We claim:

1. A molding system comprising:
extruder means for concentrically extruding an outer tubular strand having an inner diameter and an inner tubular strand having an outer diameter from respective annular nozzle openings defined between respective inner and outer nozzle walls, the strands being of resins that swell transversely as they issue from the nozzle openings;
means for positioning the nozzle walls such that the outer diameter of the inner strand is substantially smaller than the inner diameter of the outer strand and the inner strand is separated by a space from the outer strand as the strands issue from the respective nozzle openings and for engaging an outer wall of the inner strand with an inner wall of the outer strand at a spacing from the nozzle openings after substantially all swelling of the strands has taken place; and
mold means including a closed mold having a passage for drawing the strands through the passage by applying suction to a downstream end of the passage.

2. In a molding method wherein a plastic hollow preform is drawn through a mold passage formed in a closed mold by applying suction to a downstream end of a conduit having an upstream end connected to an output end of the mold passage, the improvement comprising forming the hollow preform by the steps of:
concentrically extruding an outer tubular strand having an inner diameter and an inner tubular strand having an outer diameter from respective annular nozzle openings defined between respective inner and outer nozzle walls, the strands being of resins that swell transversely as they issue from the nozzle openings;
positioning the nozzle walls such that the outer diameter of the inner strand is substantially smaller than the inner diameter of the outer strand, whereby the inner strand is separated by a space from the outer strand as the strands issue from the respective nozzle openings; and
engaging an outer wall of the inner strand with an inner wall of the outer strand at a spacing from the nozzle openings after substantially all swelling of the strands has taken place.
